(19) United States
(12) Patent Application Publication
(10) Pub. No.: US 2017/0019403 A1
(43) Pub. Date: Jan. 19, 2017

(54) METHOD FOR COMPARING USER IDENTITIES OF DATABASES

(71) Applicant: LINKILIKE GmbH, Linz (AT)

(72) Inventor: Alexander PUEHRINGER, Linz (AT)

(21) Appl. No.: 15/301,199

(22) PCT Filed: Mar. 31, 2015
(86) PCT No.: PCT/AT2015/050084

§ 371 Date: Sep. 30, 2016

(30) Foreign Application Priority Data
Apr. 1, 2014 (AT) A 236/2014

(51) Int. Cl. H04L 29/06; G06F 17/30

(52) U.S. Cl. CPC H04L 63/0861; G06F 17/30864

(57) ABSTRACT

A method compares a first identity of a first user of a first database, which first identity of the first user can be specified by means of a first input by means of a first data input device connected to a data processing device, with a second identity of a second user of a second database, which second identity of the second user can be specified by means of a second input by means of a second data input device connected to a data processing device.

### CROSS-REFERENCE TO RELATED APPLICATIONS

This application is a National Stage application of International Application No. PCT/AT2015/050084, filed Mar. 31, 2015, which claims benefit to Austrian Application No. A 236/2014, filed Apr. 1, 2014, which are incorporated by reference herein in their entireties.

### BACKGROUND

Field

This invention relates to a method for comparing a first identity of a first user of a first data base, which first identity of the first user may be provided by a first entry via a first data input device connected to a data processing device, to a second identity of a second user of a second data base, which second identity of the second user may be provided by a second entry via a second data input device connected to a data processing device.

Description of the Related Art

According to the prior art, there is a unique link between an entry of a user, or an input value created by an entry of a user, and his identity. An entry may comprise creating one input value or several input values.

DE69501327T3 discloses a biometric personal authentication method.

US2007236330 generally describes a method for verifying an identity of a user on the basis of input behavior patterns. In US2007236330, the acquisition of time values or print values is presented by way of example. US2007236330 does not disclose the use of path values.

### SUMMARY

The approach disclosed within this invention is based on the idea that every user has his individual way of entering input. As a consequence, it is possible, on the one hand, to distinguish users from one another, and, on the other hand, to distinguish an entry of a user from an automatically generated operation. The latter assumption follows from the idea that an automatically generated entry or an automatically generated input value is not a product of individuality. Furthermore, a user providing two identities can be identified as one user having one and the same identity. By the same token, the two identities of two users can be established if they use only one identity.

The invention thus has the overall object of assessing the authenticity of provided identities. Moreover, the invention disclosed below has the object of measuring and comparing the individuality of entries on the basis of physical parameters.

According to the invention, this is achieved

by measuring first physical parameters of the first entry via the first data input device, which first entry is made with respect to a first visual prompt of the first data base displayed to the first user, and which first physical parameters of the first entry comprise at least one first path value, and
by second physical parameters comprising at least one second path value as a reference parameter, or
by measuring second physical parameters of the second entry via the second data input device, which second entry is made with respect to a second visual prompt of the second data base displayed to the second user, and which second physical parameters of the second entry comprise a second path value,
so that the authenticity of the identity of the first user and/or the authenticity of the identity of the second user can be determined by comparison of the first physical parameters and the second physical parameters.

### BRIEF DESCRIPTION OF THE DRAWINGS

FIG. 1 illustrates the measurement of possible values describing a path when the disclosed method is applied to the measurement of physical parameters involving an entry by a computer mouse on a screen.

FIG. 2 illustrates another application of the method for comparing a first identity of a first user of a first data base to a second identity of a second user of a second data base.

FIG. 3 shows another application of the disclosed method in analyzing multiple-choice questions.

### DETAILED DESCRIPTION

The above mention of a first data base and a second data base describes the case where the first data base and the second data base are separated and entries from the user in these data bases are compared to each other. This may, for instance, be the case when the first entry is made on a first device like, for example, a mobile phone, while the second entry is made, for example, on a desktop computer. The data bases are, for example, stored locally on the individual devices.

Another example of a first data base is Facebook, while the second database may be Xing or Linkedin. For example, the first data of the first data base are stored on a first server, while the second data of the second data base are stored on a second server.

The invention also includes the case where the entry is made to one data base, so that the first data base and the second data base are identical. This may be the case when the devices exemplified above access one data base. This may also be the case when the first user and the second user make the entries on one device.

This is also the case when a first user and a second user make a first entry and a second entry, respectively, to a data base like Facebook, Linkedin or Xing.

An entry may, for example, comprise several partial entries.

An input device may be, for example, a keyboard, a computer mouse, a touch screen or a camera. A person skilled in the art may combine the input devices as needed.

Input devices allow a location or an area to be chosen from an input field. The path value comprises information on how the user or a selection tool controlled by the user may get from a start position to the location or area to be selected. According to current practice, for example a vector representation, the application of an equation of motion, is suitable for describing this movement.

A selection tool may be, for example, a pointer or a body part like a user's finger, foot or eye.

Input by a body part like a foot and/or finger may be measured by a touch screen. Input by a selection tool like an eye, a foot, a finger may also be measured with a camera integrated into the data processing device. The selection tool may also be a mouse pointer or a cursor controlled by the user.

The value describing a path may also refer to information on the selected area and/or the accuracy of the entry in terms of the distance from the field.

The path value may also include the information that the path value was measured to be zero following the entry. This is the case when the start location is the same as the field to be selected. This may also be the case when the input is made via a key.

The physical parameters may also comprise a time value.

A time value of an entry may, for example, be the time period from the input prompt to the implementation of the entry or the entry duration. Where an entry comprises several partial entries, the time gap between the partial entries may be measured.

Furthermore, a clock sequence may be derived from the time gap between the partial entries. Basically, the time value depends on the path value, the comprehension of the user, the skillfulness of the user and the familiarity of the user with the input device while implementing the entry.

The path value is defined as information describing the movement of the users or a movement controlled by the user. The path value is thus based on an action of the user.

The time value may describe the time period during which the path value is measured. The time value may also be a time period from a defined time up to the start of the measurement of the path value, and/or a time period after the measurement of the time value up to a defined time.

The above-described physical parameters, which comprise at least one path value or a path value combined with a time value, are characterized in that environmental influences on the input can be filtered. Environmental influences shall mean the influence of various input devices, the current physical and/or mental condition of the person or the state of health on the input. By the same token, climate factors like temperature and humidity may be filtered out. The environmental influences may be represented by an environmental factor.

These influences may essentially be identified by comparison of reference measurements.

To identify the influence of a first input device as compared to a second input device, one hundred standardized entries may be made on both entry devices to thus establish that input on the first input device is 10 percent faster than when using the second device. The influence of all environmental influences may be evaluated analogously.

The method according to the invention may be characterized in that the environmental factors are also measured when the physical parameters are measured. The latter allows for a continuous adjustment of environmental influences.

As regards the path value as a physical parameter, the input of a person may be distinguished from input by a machine or by a computer in so far as a person tends to make and enter circular and lengthy movements. As a rule, the movement of a person is irregular and does not comprise straight lines. For this reason, the movement of a person usually comprises a detour.

A movement or entry generated by a machine or by a computer is precise and can thus easily be described by a mathematical function. Imprecisions due to mechanical reasons are identified by a measure of variance.

The method may comprise routines, according to which a factor for assessment is assigned to selected path values like, for example, path values describing a polygonal course of movement or radii.

The method according to the invention may be carried out using a computer program. The computer program may comprise routines according to current practice, with which a mathematical function is chosen for describing the sequence of measured physical parameters. This routine may also comprise the step of selecting mathematical functions that are as simple as possible.

Using the mathematical functions describing the measured physical parameters, the first entry and the second entry can be compared.

The physical parameters may also comprise a value describing a static and/or dynamic force. The value describing a force may be measured using suitable input devices like touch screens as known in the art. According to the prior art, a resistive touch screen may be used for this purpose.

The entry of the user may be made after a prompt and/or voluntarily. The user makes his entry in the respective data base following a visual prompt. To this aim, the data base comprises the technological means as known in the art. A visual prompt of a data base may, for example, comprise at least one question to be answered by the user. The visual prompt may, for example, also comprise an answer to the question.

For example, the measured entry may comprise an entry in response to a prompt as a first partial entry and a voluntary entry as a second partial entry. The second partial entry may be a “playful” entry of the user during a waiting period of the user.

The comparison of the physical parameters as a part of the method according to the invention may be based on methods for comparing data bases known in the art.

Moreover, the visual prompt of the first data base may be compared to the visual prompt of the second data base in order to determine and filter out influences of the visual prompts on the entry.

The process step of comparing the first visual prompt and the second visual prompt allows for the possibility that the first data base and the second data base comprise different visual prompts provoking a first entry and a second entry, respectively. A different visual prompt may, for example, be due to different screen sizes.

By comparing the first visual prompt and the second visual prompt, the influence of the visual prompts on the entries is determined and filtered out of the entry to enable the physical parameters of the entries to be compared.

The figures serve to corroborate this disclosure. The figures and the associated description shall by no means be construed as limiting. In the figures, the following reference symbols designate the following elements.

| | |
|---|---|
| 1, 2, 3 | time period |
| 4 | screen |
| 5 | mouse pointer |
| 6, 7 | paths |
| 8, 9 | selection boxes |
| 10 | given graph |
| 11 | first traced graph |
| 12 | second traced graph |
| 13 | questions |
| 14 | answers |

FIG. 1 illustrates the measurement of possible values describing a path when the method according to the invention is applied to the measurement of physical parameters involving an entry by a computer mouse on a screen 4. The mouse pointer 5 of the computer mouse is at its start position in the lower left corner of the screen 4. The prompt for the first entry is the display of the selection box 8 and the selection box 9.

The method according to the invention offers the possibility to compare a first identity of a first user of the data base to a second identity of a virtual second user of the data base.

The first identity of the first user is provided by a first entry in the form of a path 6 using the computer mouse as a first date input device, while the second identity of a virtual second user of the data base is provided by an automatically generated second entry in the form of a path 7 via a generated movement of the mouse as a second data input device.

First physical parameters of a first entry via the mouse as the first input device are measured, which first physical parameters of the first entry comprise at least one path value. Second physical parameters of the second entry in terms of the generated movement of the second input device are measured, which second physical parameters of the second entry also comprise a path value.

The path values are used to calculate a vector representation and/or a mathematical function according to current practice, so that, by comparison of the respective physical parameters of the entries, the first user is identified as a person and the second user is identified as a virtual person.

Path 7 is straight and runs directly from the start position of the mouse pointer to the selection box 8. Path 6, on the other hand, is neither direct nor straight. The movement performed by the person includes a detour. The form of path 6 is polygonal.

The example described with reference to FIG. 1 shows the special case in which the first data base and the second data base, and thus the first visual prompt and the second visual prompt in the form of the selection boxes 8, 9, are identical.

For this reason, it is possible to compare the entry of the first user to the entry of the second user and, as a consequence, the identity of the first user to the identity of the second user. Applying the method according to the invention, this comparison is based on the comparison of physical parameters of the entries, which physical values comprise at least one path value.

Path 7 shows the first entry of the first user to move the mouse pointer 5 from the lower left corner of the screen 5 to the selection box 8. Arrow 7 shows the straight and direct path. Path 7 can easily be described by a mathematical equation like the equation of a straight line.

Arrows 6 show a second entry of the second user to move the mouse pointer 5 from the lower left corner of the screen 5 to the selection box 8. First, the mouse pointer 5 is moved close to the selection boxes 8 and 9, to then move it into the selection box 8. Path 6 is polygonal and includes a detour. Path 6 can only be described by mathematical approximation procedures according to current practice.

For this reason, measuring physical parameters comprising at least one path value may comprise measuring the movement of the mouse pointer of the computer mouse as an input device. A person skilled in the art will recognize that the movements explained above also include a time value, which is also measured during the analysis of the operation of the input device. For example, the velocity of the movement of the mouse pointer may be calculated or measured.

Path 7 is thus clearly a path which is made by a computer-generated user. It is against human nature to enter a straight path from a start position to a target position. Due to its detour, one can assume that path 6 is a path entered by a person.

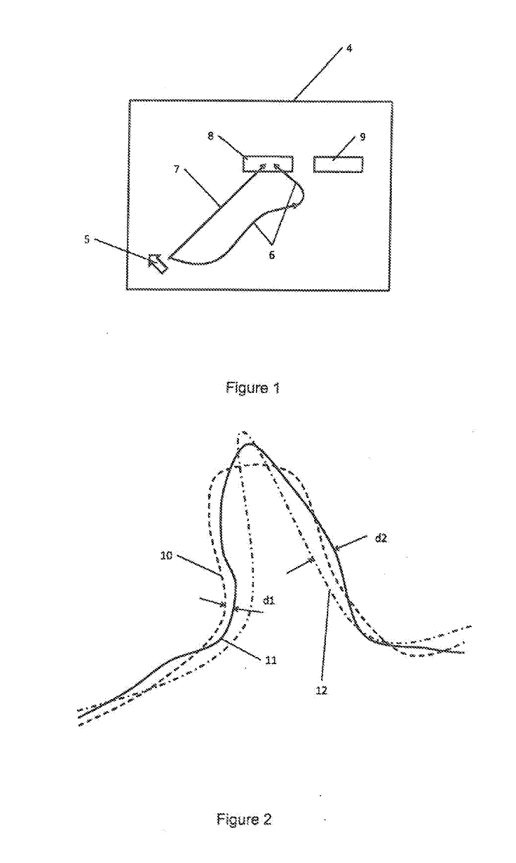

FIG. 2 illustrates another application of the method for comparing a first identity of a first user of a first data base to a second identity of a second user of a second data base according to the invention.

To this aim, a graph 10 is displayed on a screen. The user receives a prompt in terms of a visual prompt to trace the graph 10.

A first graph 11 traced by a first user serves as the first entry. The first graph 11 is compared to graph 10, whereby a distance d1 between the graphs 10, 11 can be measured as a physical parameter of the first entry. The distance d1 is a path value. Furthermore, a time value can be measured for the first entry, which is used to determine the velocity and the duration of tracing.

The first identity of the first user is thus provided by a first entry via a first data input device.

A second graph 12 traced by a second user serves as the second entry. The second graph 12 is compared to graph 10, whereby a distance d2 between the graphs 10, 11 can be measured as a physical parameter of the second entry. The distance d2 is a path value. Furthermore, a time value can be measured for the first entry, which is used to determine the velocity and the duration of tracing.

A person skilled in the art will recognize that the first graph 11 follows graph 10 for the most part, while the second graph 12 only follows the peak of graph 10 as its characteristic feature. The first user thus places a different emphasis than the second user, whereby the identities of the users can be determined by applying the method according to the invention.

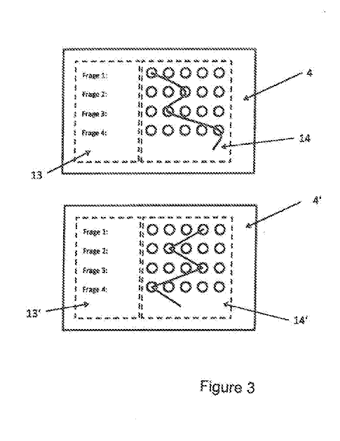

FIG. 3 shows another application of the method according to the invention in analyzing multiple-choice questions. Several questions 13, 13′ and various answers 14, 14′ are displayed on the screens 4, 4′. The user answers the questions by selecting one in each row of answers 14, 14′. Here, “entry” does not mean selecting the answer 14, 14′ by, for example, checking, but guiding the selection tool along a path 6, 7 from one answer to the next.

One possible way of application of the method according to the invention consists in comparing a first entry made by a first user having a first identity to a second entry made by a second user having a second identity.

The first entry is made via a first data base, while the second entry is made via a second data base. The entries are each made via input devices. The resulting task may be that a second entry automatically generated by a computer can be identified among a plurality of first entries by comparing it to at least one first answer of a person.

To this aim, first physical parameters of the first entry are measured, which first physical parameters of the first entry comprise a path value given by path 6.

Furthermore, second physical parameters of a second entry are measured, which second physical parameters of the second entry comprise a path value given by path 7.

The identities of the users may be compared by comparing the physical parameters of the entries. As a consequence, one can determine if a second answer was generated by a computer or was given by a user without reading the question.

Path 7 constitutes the shortest distance between the answers. Path 7 has a precise mathematical form. Path 7 meets the criteria of a movement generated by a computer.

Path 6 has a polygonal form and meets the criteria of a movement of a person.

What is claimed is:

1. A method for comparing a first identity of a first user of a first data base, which first identity of the first user may be provided by a first entry via a first data input device connected to a data processing device, to a second identity of a second user of a second data base, which second identity of the second user may be provided by a second entry via a second data input device connected to a data processing device, wherein
first physical parameters of the first entry via the first data input device are measured, which first entry is made with respect to a first visual prompt of the first data base displayed to the first user, and which first physical parameters of the first entry comprise at least one first path value, and
second physical parameters comprising at least one second path value as a reference parameter are available, or
second physical parameters of the second entry via the second data input device are measured, which second entry is made with respect to a second visual prompt of the second data base displayed to the second user, and which second physical parameters of the second entry comprise a second path value, so that the authenticity of the identity of the first user and/or the authenticity of the identity of the second user can be determined by comparison of the first physical parameters and the second physical parameters.

2. The method according to claim 1, wherein
the physical parameters of the first entry and/or the second entry comprise a first and a second time value, respectively.

3. The method according to claim 1, wherein the entry comprises several partial entries.

4. The method according to claim 1, wherein the first entry and/or the second entry of the user are made after a compulsory prompt.

5. The method according to claim 1, wherein the entry of the user is made voluntarily.

6. The method according to claim 1, wherein first attributes of the first data base are compared to second attributes of the second data base.

7. The method according to claim 1, wherein the first data base and the second data base are identical.
